(19) United States
(12) Patent Application Publication
(10) Pub. No.: US 2012/0185890 A1
(43) Pub. Date: Jul. 19, 2012

(54) SYNCHRONIZED VIDEO PRESENTATION

(76) Inventors: Alan Rouse, Lawrenceville, GA (US); Charles Dasher, Lawrenceville, GA (US); Paul Canter, Gainesville, GA (US)

(21) Appl. No.: 13/008,936

(22) Filed: Jan. 19, 2011

(51) Int. Cl. H04N 7/16; H04N 5/445

(52) U.S. Cl. 725/25; 725/38

(57) ABSTRACT

A video control device is disclosed. The video control device includes a communication interface for receiving user inputs and for communicating data to users, a memory for storing information communicated with the users and a plurality of video programs and a processor for processing the inputs received by the communication interface and for streaming video to the users via the communication interface. The communication interface receives a code from a user and from at least one of a plurality of invitees that received the code from the user. The processor streams a video program corresponding to the code simultaneously to the user and to invitees submitting the code and disables navigation functions of user controls for the invitees submitting the code.

### BACKGROUND

The invention relates to technological mechanisms for providing synchronized program content to users at multiple locations and more particularly to technological mechanisms for limiting a navigation within the content to one of the users.

A general entertainment subscription based system 100 is described with reference to FIG. 1. Each of a plurality of users 110 to 150 (designated as Users A to E) subscribe to one of service providers 1000, 1100 (designated as Service Provider X and Y). Users A, C and E may subscribe to Service Provider X while users B and D may subscribe to service provider Y for example. Each of the users typically obtain (or view) their programming via a respective one of the viewing devices 115 to 155. The viewing device can be any device with video displaying capability such as a television or a computer or a mobile communication device (such as a cellular telephone) for example.

The service providers 1000 and 1100 may both be a cable company or a telephone company or a combination thereof. Each user is connected to their respective service provider via a wired connection such as coaxial cables or fiber optic lines. The subscription based system 100 may be implemented within a geographic area such as a city, county, state, country, or portions thereof.

There exist some situations where a synchronized playback of a video such as a video on demand program is desirable. A group of people in different locations may wish to watch a video program together but are not able to physically get together for various reasons. Organizations may wish to conduct training sessions simultaneously for employees situated in different locations.

### SUMMARY

It should be emphasized that the terms “comprises” and “comprising”, when used in this specification, are taken to specify the presence of stated features, integers, steps or components; but the use of these terms does not preclude the presence or addition of one or more other features, integers, steps, components or groups thereof.

In accordance with one aspect of the present invention, the foregoing and other objects are achieved in methods, systems, and apparatuses for providing synchronized video presentation to a number of viewers at different locations.

In an exemplary embodiment, a video control device is disclosed. The video control device includes a communication interface for receiving user inputs and for communicating data to users, a memory for storing information communicated with the users and a plurality of video programs and a processor for processing the inputs received by the communication interface and for streaming video to the users via the communication interface. The communication interface receives a code from a user and from at least one of a plurality of invitees that received the code from the user. The processor streams a video program corresponding to the code simultaneously to the user and to invitees submitting the code and disables navigation functions of user controls for the invitees submitting the code.

In another exemplary embodiment, a video presentation method is disclosed. The video presentation method includes communicating an invitation including a code from a user to a plurality of invitees for viewing a video program, receiving a code for presentation of the video program from the user and at least one of the invitees, presenting the video program simultaneously to the user and to the invitees submitting the code and restricting navigation of the video program for invitees submitting the code wherein the video program is stored in a storage device.

In additional embodiments, a computer program is disclosed. The computer program includes computer readable program modules which when run on a control device causes the control device to communicate an invitation including a code from a user to a plurality of invitees for viewing a video program, receive a code for presentation of the video program from the user and at least one of the invitees, present the video program simultaneously to the user and to the invitees submitting the code and restrict navigation of the video program for invitees submitting the code wherein the video program is stored in a storage device.

### BRIEF DESCRIPTION OF THE DRAWINGS

The objects and advantages of the invention will be understood by reading the following detailed description in conjunction with the drawings in which:

FIG. 1 illustrates a subscription based entertainment system over a geographic area.

FIG. 2 illustrates a system in accordance with exemplary embodiments.

FIG. 3 illustrates a method in accordance with exemplary embodiments.

### DETAILED DESCRIPTION

The various features of the invention will now be described with reference to the figures, in which like parts are identified with the same reference characters.

The various aspects of the invention will now be described in greater detail in connection with a number of exemplary embodiments. To facilitate an understanding of the invention, many aspects of the invention are described in terms of sequences of actions to be performed by elements of a computer system or other hardware capable of executing programmed instructions. It will be recognized that in each of the embodiments, the various actions could be performed by specialized circuits (e.g., analog and/or discrete logic gates interconnected to perform a specialized function), by one or more processors programmed with a suitable set of instructions, or by a combination of both. The term “circuitry configured to” perform one or more described actions is used herein to refer to any such embodiment (i.e., one or more specialized circuits and/or one or more programmed processors).

Moreover, the invention can additionally be considered to be embodied entirely within any form of computer readable carrier, such as solid-state memory, magnetic disk, or optical disk containing an appropriate set of computer instructions that would cause a processor to carry out the techniques described herein. Thus, the various aspects of the invention may be embodied in many different forms, and all such forms are contemplated to be within the scope of the invention. For each of the various aspects of the invention, any such form of embodiments as described above may be referred to herein as “logic configured to” perform a described action, or alternatively as “logic that” performs a described action.

The inventors of the subject matter described herein have recognized that synchronizing the playback of a video program, such as video on demand, for several viewers in multiple locations would be useful. It permits the users to have the virtual experience of watching a program together.

In general, exemplary embodiments are directed to facilitating the simultaneous viewing of a video program by a plurality of users in multiple locations wherein the synchronized aspect is coordinated or controlled by one user (referred to herein as a coordinating user or master controller).

The coordinating user may schedule a viewing event by (identifying and) inviting a plurality of other users (i.e. invitees) to view a video program. The invitation may include a unique code and an identification of the video program and a time of the program presentation both of which may be included in the unique code. The invitation may be submitted from a number of interfaces. It can be sent by electronic mail (e-mail), submitted via a website or via a software application running on a set-top box such those used in home entertainment systems.

The invitees that choose to (or can) view the event may enter the unique code received from the coordinating user at the time of the video program presentation. The code may be entered via a remote control to a software running on a set-top box or via an EBIF (enhanced TV binary interchange format) application.

Each of the invitees and the coordinating user all obtain their television programming from service providers such as a cable company, a telephone company or other similar entities, i.e. they all subscribe to a service provider for their television programming.

The video program may be ready for presentation at the time specified in the invitation. The presentation may commence when the coordinating user actuates a play button. Upon actuation of the play button, the video program being presented to the invitees is synchronized with that being presented to the coordinating user.

As the video program is playing, the coordinating user also controls navigation of (or within) the video program that is being presented. That is, the coordinating user may execute functions such as pause, forward, rewind, pause, etc. The results of this execution results in a similar effect in the video program of all users including the invitees. That is, if the coordinating user executes a pause function, then the video program being presented to coordinating user is paused and at the same time, the video program for the invitees is also paused. The coordinating user could be viewed as taking control over presentation of the video program (i.e. master controller).

In exemplary embodiments, the invitees choosing to view the video program may have no control over the navigation within the video program. That is, the navigation functions (such as pause, rewind, fast forward, etc.) for the invitees are disabled and any attempts to execute these functions by the invitees are not processed.

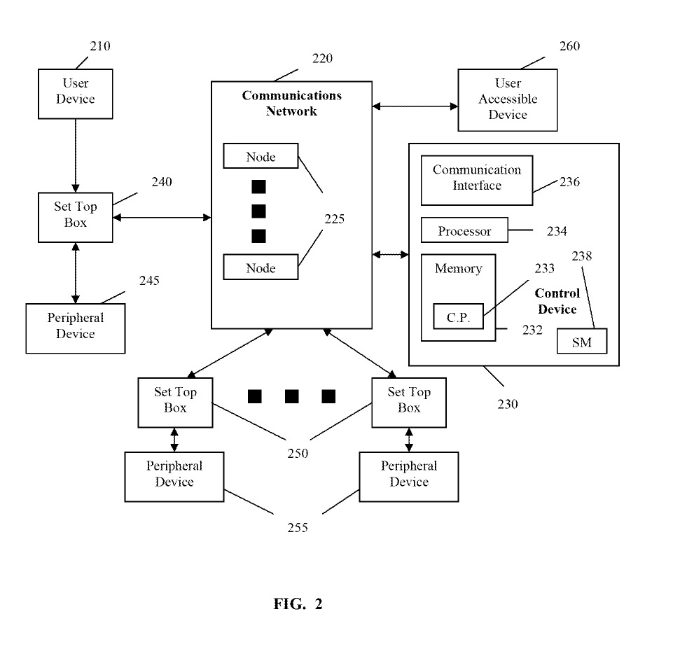

A synchronized video viewing system for facilitating exemplary embodiments may be described with reference to FIG. 2.

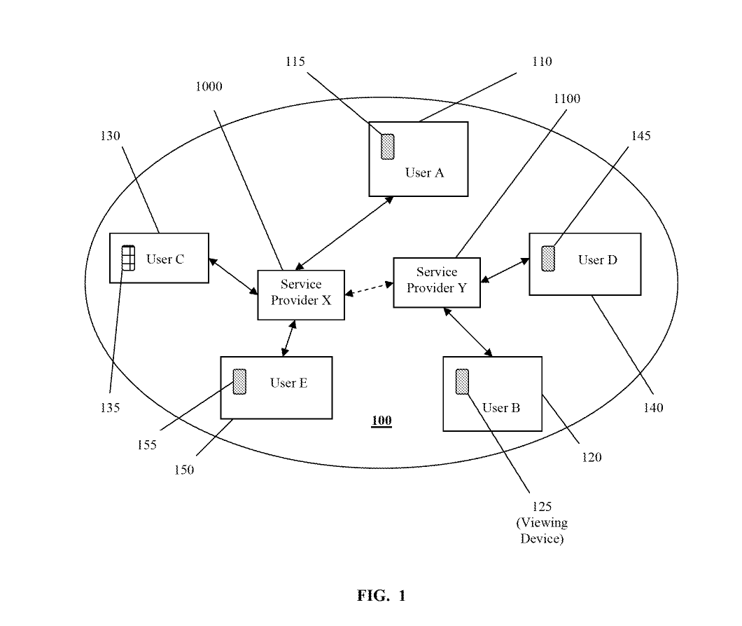

A user such as User A 110 of FIG. 1 may invite a number of other users (such as User B 120, User C 130, User D 140 and User E 150) to view a video program together. As described above, User A may submit the invitation from user device 210 which can control a software application within a set top box 240. The invitation may be communicated by user device 210 to a control device 230 via set-top box 240 and a communication network 220.

The set-top box 240 may be in bi-directional communication with the control device 230 via communications network 220. The communication link between set-top box 240 and network 220 as well as that of network 220 and control device 230 may be a wired connection. Communication network 220 may include a number of nodes 225 and can be coupled to any number of other set-top boxes 250 as is known in the art.

Control device 230 may be viewed as being a part of, or connected to, a cable backend. It may be a server and include, inter alia, a communication interface 236 for receiving the invitation from User A 110 and to submit/forward the invitation to the invitees (Users B, C, D and E in this example). The invitees may obtain access to the video program via set top boxes 250 for example.

Control device 230 may also include memory 232 for storing video programs. The memory may be a physical storage medium. Video programs in memory 232 may include the video program identified in the invitation along with other video on demand titles for example. Set-top boxes such as boxes 240 and 250 are known and used in cable television systems for example. These systems provide control television programming in homes, places of business, hotels, etc.

At the designated time, some or all of the invitees along with User A may enter the unique code received in the invitation to commence viewing of the video program. One of the invitees (such as User C 130) may choose not to or is not able to view the program.

Based on the unique code, control device 230 may retrieve and make the identified video program available to User A and to the plurality of invitees accepting the invitation (Users B, D and E in this example).

User A 100 who may be designated as the controlling user or master controller in this case. Control device 230 may monitor for a play command from User A. A control device may be at a cable backend and may include a video pump control as described in Real Time Streaming Protocol (RTSP) or Lightweight Stream Control Protocol (LSCP) for example. Upon actuation of the play function by User A, a message may be transmitted to a synchronization module SM 238. The command (i.e. play in this example) is communicated to the cable headend and distributed to the various video pumps that are being controlled. The command need not be sent to the individual set-top boxes 250 (corresponding to the invitees for example); these boxes may simply receive the video stream that being controlled by the video pumps

The playback controls from User A such as forward, rewind, pause, etc. may be processed in a similar manner by the control device 230. Therefore, if User A actuates a forward function, a rewind function or a pause function, SM 238 may issue the same command (i.e. forward, rewind or a pause to the set-top boxes of all the invitees. During the video program, control device 230 ignores any playback commands from the invitees. Therefore, if User B chooses to forward or rewind or pause, the program on his or her peripheral device 255 does not respond to these commands.

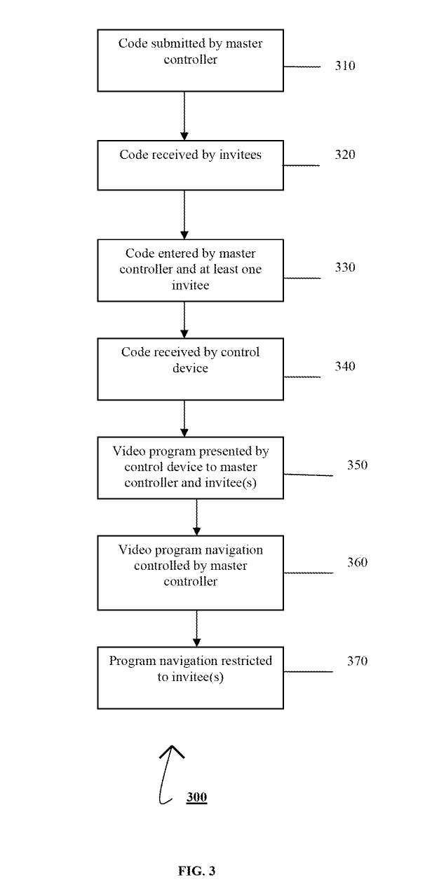

A method for facilitating exemplary embodiments may be described with reference to FIG. 3.

The master controller may invite a plurality of users or invitees to view a video program and submit (or, by submitting) a unique code to the invitees at 310. The unique code may include or represent the identify of a video program and a time of presentation. The code may be received by the invitees at 320. The master controller and at least one or more invitees that choose to view the video program may enter the unique code at 330. This code may be received by a video control device (such as control device 230 of FIG. 2 at a cable backend for example) at 340.

The video program may be played (or streamed) simultaneously for the master controller and to the invitees that entered the unique code at 350. The navigation within the playing of the video program is controlled by the master controller at 360. While the video is playing, the navigation functions for the invitees entering the code are disabled at 370. The video program that is presented to the invitees entering the code is synchronized with the video program that is presented to the master controller.

In one embodiment, in order for the processor 134 to be able to perform the steps illustrated in FIG. 3, the memory 132 comprises a computer program (CP) 133 with computer program modules which when run by the processor 134 causes the control device 130 to perform all or some of the steps illustrated in FIG. 2. The memory may for example be a flash memory, a RAM (Random-access memory) ROM (Read-Only Memory) or an EEPROM (Electrically Erasable Programmable ROM), and the computer program modules described above could in alternative embodiments be distributed on additional memories (not shown) in the control device 130. The processor may not only be a single CPU (Central processing unit), but could comprise two or more processing units. For example, the processor may include general purpose microprocessors, instruction set processors and/or related chips sets and/or special purpose microprocessors such as ASICs (Application Specific Integrated Circuit). The processor may also comprise board memory for caching purposes.

Some of the invitees may subscribe to a service provider that is different from the service provider subscribed to by the master controller. The multiple service providers may be connected via interconnecting links. A video program may also originate from multiple locations depending on the geographic region of the controller/viewer/invitee for example. In order to account for potential delays in communicating commands from the master controller to the invitees due to distance for example, the commands such as pause, play, etc. may also include a frame identifier where the pause occurs or where the play resumes. As a result, the synchronization aspect according to exemplary embodiments may be maintained.

The source of the video program can be other entities such as video libraries, etc. The cost of providing video programs to multiple viewers can be negotiated (for a discount) and billed to one entity such the master controller for example. The master controller can be a social club having viewers as members.

While exemplary embodiments have been described with reference to video programs, it may be equally applicable to audio or any type of multimedia presentations. It is not limited to video on demand, it is equally applicable to live events being streamed by the service providers.

The various communication links described may be wired, wireless or a combination (of wired and wireless) that provide bi-directional data communication with private data streams.

In some embodiments, the invitees may communicate with each other or with the master controller while viewing the program via a separate channel that facilitate private streams to each participant. These streams may provide bi-directional communication.

Various embodiments provide one or more advantages. It enables a number of viewers to engage in a group or social activity from different locations. It also facilitates simultaneous training of individuals at different locations.

The invention has been described with reference to particular embodiments. However, it will be readily apparent to those skilled in the art that it is possible to embody the invention in specific forms other than those of the embodiment described above. The described embodiments are merely illustrative and should not be considered restrictive in any way. The scope of the invention is given by the appended claims, rather than the preceding description, and all variations and equivalents which fall within the range of the claims are intended to be embraced therein.

What is claimed is:

1. A video control device comprising:
a communication interface for receiving user inputs and for communicating data to users;
a memory for storing information communicated with the users and a plurality of video programs; and
a processor for processing the inputs received by the communication interface and for streaming video to the users via the communication interface, wherein
the communication interface:
receives a code from a user and from at least one of a plurality of invitees that received the code from the user, and
the processor:
streams a video program corresponding to the code simultaneously to the user and to invitees submitting the code; and
disables navigation functions of user controls for the invitees submitting the code.

2. The video control device of claim 1, wherein the processor streams the video at a time identified in the code.

3. The video control device of claim 1, wherein the processor maintains the navigation functions for the user.

4. The video control device of claim 3, wherein the navigation functions include pausing, forwarding and rewinding of the video program.

5. The video control device of claim 1, wherein the streaming video is a video on demand.

6. The video control device of claim 1, wherein the streaming video is a live event.

7. The video control device of claim 1, wherein the streaming video is a training video.

8. The video control device of claim 1, wherein the communication interface communicates with a second control device if at least one of the invitees submitting the code subscribes to a video service provider different from a video service provider of the user providing the input.

9. The video control device of claim 1, wherein the video is streamed via a cable.

10. The video control device of claim 1, wherein the input issued by the user is received via at least one of: a cable set-top box, a mobile communication device via a network, and a computer via a network.

11. A video presentation method comprising:
communicating an invitation including a code from a user to a plurality of invitees for viewing a video program;
receiving a code for presentation of the video program from the user and at least one of the invitees;
presenting the video program simultaneously to the user and to the invitees submitting the code; and
restricting navigation of the video program for invitees submitting the code wherein the video program is stored in a storage device.

12. The method of claim 11, wherein the code includes an identity and a time of presentation of the video program.

13. The method of claim 11, wherein the video program is a video on demand.

14. The method of claim 11, wherein a location of the user is different from a location of at least one of the accepting invitees.

15. The method of claim 11, further comprising:
the user executing the navigation functions of the video program.

16. The method of claim 15, wherein the navigation functions include pausing, forwarding and rewinding of the video program.

17. The method of claim 11, further comprising:
submitting the invitation via at least one of a television connected to a cable set top box, a mobile device and a computer.

18. The method of claim 11, further comprising:
presenting the video program on at least one of a television, a mobile device and a computer.

19. The method of claim 11, wherein the first user and at least one of the invitees submitting the code subscribe to different video service providers.

20. A computer program comprising computer readable program modules which when run on a control device causes the control device to:
communicate an invitation including a code from a user to a plurality of invitees for viewing a video program;
receive a code for presentation of the video program from the user and at least one of the invitees;
present the video program simultaneously to the user and to the invitees submitting the code; and
restrict navigation of the video program for invitees submitting the code wherein the video program is stored in a storage device.
